(19) United States
(12) Patent Application Publication
(10) Pub. No.: US 2007/0105043 A1
(43) Pub. Date: May 10, 2007

(54) Photosensitive coating for enhancing a contrast of a photolithographic exposure

(76) Inventors: Klaus Elian, Bubenreuth (DE); Christoph Noelscher, Nuernberg (DE)

Correspondence Address: SLATER & MATSIL LLP, 17950 PRESTON ROAD, SUITE 1000, DALLAS, TX, 75252, US

(21) Appl. No.: 11/584,806

(22) Filed: Oct. 20, 2006

Related U.S. Application Data
(63) Continuation-in-part of application No. 11/256,677, filed on Oct. 21, 2005.

(51) Int. Cl. G03C 1/00

(52) U.S. Cl. 430/270.1

(57) ABSTRACT

A photosensitive coating material for enhancing a contrast of a photolithographic exposure of a resist film formed on a substrate, including a base polymer, a solvent for facilitating deposition of the photosensitive coating material upon a surface adjacent to said resist film to form a film thereupon, an alkaline additive suited to diffuse into the adjacent resist for reducing or neutralizing an acid concentration formed locally therein, a photoactive component arranged to reduce or neutralize a concentration of the alkaline additives in portions of the photosensitive coating, which are exposed with optical light, UV- or X-ray radiation, electrons, charged particles, ion projection lithography.

This application is a continuation-in-part of and claims the priority benefit of commonly owned U.S. patent application Ser. No. 11/256,677 filed Oct. 21, 2005, which is incorporated herein by reference.

### TECHNICAL FIELD

The invention relates to a photosensitive coating for enhancing a contrast of a photolithographic exposure of a resist formed on a substrate. The invention further relates to multilayer resists.

### BACKGROUND

In the field of semiconductor manufacturing, integrated circuits are formed by exposing semiconductor wafers layer by layer with each a pattern formed on respective masks of a dedicated set. The wafers are thereby covered with a photosensitive resist, which is coated on the layer currently to be exposed. With the ongoing decrease of feature sizes, so-called lithographic enhancement techniques are utilized in order to increase the resolution and depth of focus with respect to an exposure. These techniques relate to improvements in the optical systems (exposure apparatus), types of masks (phase shift masks, trimming masks, etc.) or the resists.

One phenomenon that often occurs, when features are printed onto a wafer having a width near the resolution limit of the optical system, is the formation of side lobes near the main feature in the resist on the substrate. These side lobes correspond to side maxima of an intensity distribution, which are due to interference effects.

The side maxima are disadvantageously aggravated if the optical system, in particular the lenses, suffer from aberration. The intensity of such a side maximum may reach a threshold value, for which the resist is effectively exposed. The corresponding resist portions will thus be removed in a subsequent development step. An undesired formation of a feature in an underlying layer after performing an etch step may result.

The formation of undesired features also occurs when assist features having sub-resolution size affect a local intensity maximum, which exceeds a threshold value of the resist. This may similarly be due to an optical aberration of the lens system.

Lithographic enhancement techniques further deal with a strong need for enhancing the optical contrast of an exposure. The optical contrast is defined as the difference between the maximum and minimum intensity of an imaged pattern, divided by the sum of both intensities. Analogously, the acid contrast is defined by the difference of maximum and minimum acid concentrations divided by their sum.

In Leuschner, R. and Pawlowski, G.: “Photolithography, Handbook of Semiconductor Technology Processing of Semiconductors”, Materials Science and Technology, Vol. 16, Wiley-VCH, 1998 is disclosed a method of enhancing the contrast by forming a bi-layer resist, wherein the uppermost layer serves as the contrast enhancing layer. This layer has a strong absorption until it becomes transparent by bleaching during the exposure when a sufficient dosis is reached.

Regions of this contrast-enhancing layer (CEL), which are not exposed are thus still absorptive and the underlying resist film thus receives a reduced amount of exposure light beneath these regions. As a consequence, the sidewall slopes of the lines formed in the resist after development are considerably steepened. However, this approach involves problems when using chemically amplified resists (CAR) as the underlying resist, since CAR resists allow only moderate doses in an exposure.

An alternative method of improving the contrast is proposed in Tsujita, K. and Mita, I., “Improvement of a deteriorated Resolution caused by Polarisation Phenomenon with TARC Process”, Optical Microlithography XVII, Proceedings of SPIE Vol. 5377, pp. 80-90, 2004. There, a top antireflective coating (TARC) is disclosed, which enhances contrast by reducing the polarization effects, which would otherwise deteriorate the exposure quality.

A further method for increasing the contrast and reducing the occurrence of side lobes is disclosed in Jung et al., “Quencher Gradient Resist Process for Low K Process”, Advances in Resist Technology and Processing XXI, Proceedings of SPIE, Vol. 5376, pp. 63-70, 2004. According to this approach, a resist top coating contains a polymer matrix with alkaline additives. During a post-exposure bake (PEB) the alkaline additives diffuse into the underlying resist film. Therein, an acid generated during an exposure is neutralized, or quenched. This quenching process yields an overall reduction of the acid concentration near the surface of the resist. As a result the acid concentration in the vicinity of a side lobe falls below the threshold value thus leading to a non-printing of the side lobe.

The main structure formed on the wafer, which corresponds to the pattern on the mask, is also slightly affected at its margins. Consequently, the width of a structure resulting from an exposure is somewhat smaller than if no top coating had been used upon the resist. Further, as the alkaline outdiffusion from the top coating into the resist film only affects a surface portion of the resist film, the profile of a resist web develops a T-form, i.e., an overhanging profile due to the more ineffective exposure near the resist surface.

### SUMMARY OF THE INVENTION

In one aspect, the invention improves the contrast achievable during an exposure, a subsequent bake and a development in a resist. In a further aspect, a reduction in the occurrences of side lobes in a photolithographic process step can be achieved. In yet a aspect, the invention improves the resolution and the depth of focus with regard to photolithographic exposure.

In a first embodiment, a photosensitive coating material is provided for forming a contrast enhancing layer (CEL) with respect to a resist film, which is formed on a substrate. The coating material includes a base polymer. A solvent for facilitating deposition of the photosensitive coating material is disposed upon a surface adjacent to the resist to form a film thereupon. An alkaline additive is suited to diffuse into the adjacent resist for reducing or neutralizing an acid concentration formed locally therein. A photoactive component is arranged to reduce or neutralize a concentration of the alkaline additives in portions of the photosensitive coating that are exposed with optical light, UV- or X-ray radiation, electrons, charged particles, ion projection lithography.

In another embodiment, a multilayer coating is disposed on a substrate prior to photolithographic exposure. The coating includes at least one resist film, and a contrast enhancing layer (CEL), which is deposited upon the resist film. The CEL includes a base polymer, an alkaline additive that is suited to diffuse into the adjacent resist, and a photoactive component arranged to reduce or neutralize a concentration of the alkaline additives in portions of the photosensitive coating, which are exposed with the optical light, UV- or X-ray radiation, electrons, charged particles, ion projection lithography.

The resist film may include a further base polymer having an acid sensitive group and also can be photoinsensitive in a further embodiment of the invention. Such a photoinsensitive resist film can be free of any photolytic acid generators or photoactive components in general. In such an embodiment of the invention the photoinsensitive resist film itself is not sensitive for exposure with optical light, UV- or X-ray radiation, electrons, charged particles, ion projection lithography, because during exposure, no acids are formed in the photoinsensitive resist film due to the absence of the photolytic acid generators. Instead, during exposure of the multilayer coating, acids are formed in the contrast enhancing layer, which can comprise photolytic acid generators as a photoactive component, and which is located on top of the photoinsensitive resist film. The acids formed in the photoinsensitive resist film can then diffuse into the photoinsensitive resist film during the exposure and during a post exposure bake and can alter the polarity of the base polymer for example via acid-catalyzed cleavage of acid-labile groups. In this case the photoinsensitive resist film for example can be selected to have a good etch stability, a high resolution and a good line edge roughness (LER) without being sensitive to exposure with optical light, UV- or X-ray radiation, electrons, charged particles, ion projection lithography. In such an embodiment of the present invention the above mentioned properties of the photoinsensitive resist film can be adapted and improved without having to take into consideration a possible negative impact on the exposure sensitivity of the resist film. In addition the photoinsensitive resist film can also be poorly transparent or even opaque to the radiation used during exposure, because the acid for forming the latent image in the resist film is delivered by the contrast enhancing layer.

In yet a further embodiment of the invention the resist film may include a further base polymer having an acid sensitive group and also a photolytic acid generator for generating an acid under exposure with optical light, UV- or X-ray radiation, electrons, charged particles, ion projection lithography forming a photosensitive resist and in a preferred embodiment of the invention a so-called chemically amplified photosensitive resist. The acid is arranged to release the acid sensitive group for altering the polarity of the first base polymer in order to provide a selective removal of portions, comprising altered first base polymers with respect to a developer solution. The photosensitive resist or photoinsensitive resist might further contain alkaline quenchers, for example amines, which are supposed to quench the effect of the acids released upon photolytic decomposition of the photolytic acid generators in order to limit the effect of the acids to certain regions of the resist, thereby reducing a further diffusion of these acids into regions of the resist film further away.

According to a further aspect, a substrate is provided having a surface that comprises the multilayer coating according to the previous aspect. Methods of manufacturing the photosensitive coating material and of exposing a semiconductor wafer using this material are also provided in the appended claims.

The photosensitive coating material as described according to aspects and embodiments of the invention is also referred to throughout this document as a “chemically amplified contrast enhancement layer”, CCEL, or simply as a photosensitive CEL. The CCEL is used as a top coat to be formed upon a resist film.

Contrast enhancing layers, and the “CCEL” as proposed herein, have the implicit feature that these are completely soluble in exposed and unexposed areas with respect to an agent (developer or another medium, for example a removal solvent of a protective coating in immersion lithography), which distinguishes them from a resist. The latter may be formed into an etch mask, which is effected by making portions of the resist film selectively soluble with respect to a developer due to an exposure. The feature of being photosensitive by means of the photoactive component according to embodiments of the invention, however, does not imply that a selective solubility is achieved in different portions of the coating.

It is important that alkaline additives may diffuse out of the photosensitive coating film into the photosensitive or photoinsensitive resist film within unexposed and low exposed portions. According to one embodiment of the invention, acids may be generated by a photoactive component to reduce the concentration of alkaline additives within the coating film (CCEL) and to accomplish acid diffusion into the underlying resist film within exposed portions.

With regard to the term “alkaline” as used herein, it is understood that material such as water having a bigger pka-value as acids is also included, as it is similarly suited to achieve the effects of the invention as described below.

With regard to the term “substrate”, it is understood herein, that the substrate may comprise a base body of a specific material such as silicon, glass or quartz, and further one or more layers deposited on top of the surface of this body. In some of the embodiments described later herein, the body may also explicitly be referred to as the substrate.

It is preferred that both layers are formed adjacent to each other, i.e., they are in direct contact with each other. Further, as side lobes frequently develop near the upper surface of the resist film and the diffusion length of the acid and alkaline molecules is too short to completely penetrate the resist film, the use of the photosensitive contrast-enhancing coating as a top coat is also preferred. In this case, the diffusing molecules may easily reach the region, where side lobes may arise.

In a further embodiment of the invention the photosensitive coating material comprises a photoactive component. This component serves to reduce or neutralize the concentration of alkaline additives under exposure, i.e., within exposed regions as opposed to unexposed regions in the coating film/CCEL. Two aspects, which may be combined, relate to embodiments of the photoactive component. In one embodiment, the photoactive component is a photolytic acid generator, in another embodiment, the photoactive component is provided by the alkaline additive itself, which is then photodecomposable.

The outdiffusion of alkaline molecules—or optionally in the case of the photolytic acid generator: of the acid molecules within exposed regions—primarily occurs during heating of the resist film and the photosensitive coating in a so-called post-exposure bake step. The post exposure bake step can be carried out at temperatures from 50° C. to 170° C., preferably at temperatures of 70° C. to 140° C. for 30 seconds to 120 seconds, preferably for 60 seconds to 90 seconds. The photosensitive coating contacts the resist film, which causes outdiffusion of the alkaline additives during this bake step within non- or sparsely exposed areas. This outdiffusion leads to a neutralization, or quenching, of acids generated in the resist film during an exposure. Due to the finite diffusion length, the quenching occurs in a region near the contact surface between the resist film and the photosensitive coating.

Unexposed and low exposed regions in the resist film comprise a comparatively low acid concentration such that the quenching will lead to a weaker acidity or even a basicity in that region.

If on the contrary a region of the photosensitive coating is exposed, the photolytic acid generator therein yields the development of an acid concentration during the exposure and the subsequent post-exposure bake may lead to an outdiffusion of these acids from the CCEL into the adjacent resist film and thereby the effect of T-topping is avoided.

Alternatively, a photodecomposable alkaline additive yields a reduction of alkaline concentration in exposed regions of the coating film, and thus alkaline outdiffusion into the underlying resist film is inhibited, or at least reduced.

In a further embodiment of the invention the acids generated by the photolytic acid generators can comprise charged or polar acids, for example protons H⁺. In most cases the photolytic acid generators can decompose upon exposure to a positively charged protonic acid and a negatively charged anion. Examples for such photolytic acid generators are triphenylsulfonium-triflates, triphenylsulfonium-hexaflates or triphenylsulfonium-nonoflates, Diphenyliodonium-hexaflates, which can be used alone or in combination with each other. In this case an electrical field can be applied along the contrast enhancing layer and the photosensitive or photoinsensitive resist film in order to directionally diffusion the charged or polar acids into the exposed portions of the resist film. The electrical field can be in the order of 50 V to 8000 V. Applying such an electrical field can advantageously reduce the lateral diffusion of the acids generated by the photolytic acid generators thereby enhancing the contrast between exposed and unexposed regions of the contrast enhancing layer and the photosensitive or photoinsensitive resist film. Furthermore the diffusion length of the acids into the resist film, which in most cases is restricted to a region near the contact surface between the resist film and the photosensitive coating/CEL can be enhanced by applying such an electrical field, so that the contrast between exposed and unexposed regions is also enhanced in regions of the resist film, which are further away from the contact surface between the resist film and the photosensitive coating/CEL. One possibility to apply an electrical field along the contrast enhancing layer and the photosensitive or photoinsensitive resist film is to place the layer arrangement of the contrast enhancing layer and the resist film between two capacitor plates of a device, which can basically function as a capacitor and to apply a voltage so that the electrical field is generated. In such a case the lines of electrical flux can be orientated nearly perpendicular to the above mentioned layer arrangement, so that a directional diffusion of the acids along the lines of electrical flux can occur, reducing or even suppressing the lateral diffusion of the acids within the layer arrangement. Such a device for applying the electrical field can for example be an electrical field hotplate. In a further preferred embodiment of the invention the alkaline additives, which are supposed to quench the acids in unexposed areas of the resist film comprise neutral, uncharged particles for example amines, which are not or only to a minor extent affected by the electrical field. Therefore the alkaline additives can still diffuse from the contrast enhancing layer into the resist film, even when an electrical field is applied.

In a further embodiment of the invention the electrical field is applied during the post exposure bake step in a so-called electric field enhanced post exposure bake (EFE-PEB). In such a case the layer arrangement of the contrast enhancing layer and the photosensitive or photoinsensitive resist film is heated while an electrical field is applied. Due to the fact that the diffusion of the acids primarily occurs during this heating step such an EFE-PEB can advantageously decrease or nearly suppress the lateral diffusion of the acids and can enhance the desired vertical diffusion of the acids primarily into the exposed portions of the resist film.

Referring back to the case of a photolytic acid generator, the ratio of reacting acid generated in the CCEL to that of the alkaline additives is preferably larger than 1 in the intentionally exposed areas, such that the acidity in the resist film is effectively increased. For example the photosensitive coating material for forming the contrast enhancing layer (CEL) might comprise as a solvent 10 to 90 weight %, preferably 30 to 70 weight % of water, 10 to 90 weight %, preferably 30 to 70 weight % of isopropanole, 1 to 30 weight %, preferably 5 to 15 weight % of polyacrylic acid as a base polymer, 0.2 to 10 weight %, preferably 0.5 to 3 weight % of triphenylsulphonium-hexafluorpropanesulfonate as the photoactive component and 0.02 to 1 weight %, preferably 0.02 to 0.3 weight % of trioctylamine as the alkaline additive.

However, a ratio smaller than 1 is also encompassed by the present invention for the sparsely or unexposed areas. As the acidity is increased in the exposed regions, the contrast towards the margin of an exposed region may be considerably enhanced, because beyond this margin the acid concentration has been decreased as explained above due to quenching. Further, the side lobes occurring beyond this margin are also effectively suppressed.

Accordingly, one effect of the invention is that the chemical contrast in acid concentrations between exposed and unexposed regions in the resist is enhanced. As the optical contrast correlates with the contrast in acid concentration, embodiments of the invention work as if the optical contrast had been enhanced. Therefore, according to an embodiment, a photosensitive coating is provided and combined with a further layer of a resist, wherein, e.g., attempts to improve the optical contrast may presently be supported by means of a chemical contrast enhancement.

The photosensitive coating material to be disposed as a contrast enhancing layer may, according to an embodiment, be realized by a base polymer which, according to a preferred embodiment, is soluble in a solvent, which is different to the solvent used to dissolve the resist film beneath. For example the photosensitive coating material might be based on a polyacrylic acid platform. The polyacrylic acid is soluble in water or in mixtures of isopropanole and water. Water or mixtures of water and isopropanole may be taken as solvents for disposing the photosensitive coating on the wafer. Conventional methods such as spinning may be used to apply the coating to the substrate. In a pre-bake step the solvent is removed from the coating leaving a hardened resist on the substrate. The water-based solvents as described above have the advantage of avoiding undesired intermixing effects between both layers, when a common resist solvent, e.g., Methoxypropylacetate, Ethayllactate, Cyclohexanone, Cyclopentanone, γ-Butyrolacton, Ethylacetate, etc., has been used for the under- or overlying resist film. In a further preferred embodiment of the invention the base polymer of the photosensitive coating material to be disposed as a contrast enhancing layer might be free of any acid cleavable groups so that an exposure with optical light, UV- or X-ray radiation, electrons, charged particles, ion projection lithography might generate acids due to the photolytic decomposition of the photoactive component, but might not alter the polarity of the base polymer in order to render it soluble in a developer.

According to a further embodiment the photolytic acid generator comprises triphenylsulphonium or diphenyliodonium salts of strong sulphonic acids, which are also called Crivello salts. For example, triphenylsulphonium-nonafluorbutanesulphonate or diphenyliodonium-p-toluolsulphonate may be used for the photolytic acid generator. If acids are generated by exposing areas comprising the Crivello salts, a gradient in acidity between alkaline dominated areas and acid dominated areas already within the top coat develops. This gradient is then transferred into the underlying resist by means of diffusion. An additional contrast enhancement at the edges of exposed areas results from this transferral.

The alkaline additive may, according to a further embodiment, be chosen from the class of organic amines. For example trioctylamine or trietanolamine may be used for the alkaline additive.

According to the alternative aspect of a photodecomposable alkaline additive, triphenylsulphonium acetate may be employed to form a photolytic base annihilator. In this case, a photolytic acid generator may be superfluous in certain embodiments of the invention. In exposed areas the portion of alkaline additives is reduced or neutralized by a base concentration of acids within the top coat, while in sparsely or unexposed areas the alkaline additives are retained and may diffuse into the underlying resist film as explained above. In one embodiment a photodecomposable base may advantageously be combined with a photolytic acid generator.

According to a further embodiment, which relates to both aspects, a photolytic acid generator and/or a photodecomposable base formed within the top coat, the photosensitive coating is arranged to be nearly transparent having an absorption coefficient k of less than 0.05. In this case, the exposure dose is mainly forwarded to the underlying resist (if the photosensitive coating is embodied as a top coating) in order to define exposed regions therein.

According to another embodiment the photosensitive coating is arranged to have a refractive index of less than 1.7 and of more than 1.0 for exposure in gaseous exposure systems. The refractive index then advantageously ranges between that of the underlying resist film und the gas purged through the exposure system thus yielding a reduced reflection at the contact surface between the coating and the resist film.

Therein the transparency may be adjusted by varying the composition of photolytic acid generators and alkaline additives. The refractive index, however, is affected by the specific choice of the polymer and the manner in which the coating is applied to the substrate surface, e.g. spinning or baking.

According to a further embodiment, the photosensitive coating may be selectively developable in the exposed regions with respect to unexposed regions. This means that a development step removes the exposed regions of the photosensitive layer on top of the resist film as well as within the resist film.

Alternatively, the photosensitive coating may be selectively developable, but the (underlying) resist film has to be developed in a second development with respect to the contrast-enhancing photosensitive coating.

In a preferred embodiment, the photosensitive coating is completely developed, be it an exposed or unexposed region. Thereafter, the exposed regions of the resist film are removed in the same or in a further development step.

Another aspect deals with a photosensitive coating applied to a resist film for exposure in a water-based immersion system as the exposure apparatus. Herein, the top coat has to be arranged such that it is not dissolvable with respect to water. The base polymer, therefore, comprises copolymers based on polyvinylalcohole, polymethylmetacrylate, or polyacrylic acid. For example, such a copolymer may be obtained by gradually replacing acid groups of the polyacrylic acid with alcohols thus providing less polarity. When using these copolymers, pure isopropanole is preferred for usage as a solvent.

According to yet another embodiment of the invention a so-called “bottom contrast enhancement layer” (BCEL) is provided that functions to enhance the contrast in and after an exposure of the resist film deposited on top of the BCEL. In particular, the photosensitive coating of the BCEL is deposited below the resist film and alters (improves) the signature (acid concentration profile) of an exposure in a bottom region of the resist film. The photosensitive coating material for forming the BCEL includes

a base polymer, which is free of any acid cleavable groups for being insoluble with respect to a developer, which is designed to remove exposed portions of said resist film;

a solvent for facilitating deposition of the photosensitive coating material upon a surface of a substrate; and

a photolytic acid generator, which is arranged to release an acid under exposure with optical light, UV- or X-ray radiation, electrons, charged particles, ion projection lithography, the acid arranged to diffuse into the adjacent resist film deposited upon the layer formed from the photosensitive coating material.

The “BCEL” as proposed herein has the feature of being insoluble with respect to a developer solvent, which is designed to remove the base polymer of a resist film, which was de-blocked due to an acid-catalyzed cleavage of acid-sensitive groups of the base polymer. The base polymers of the BCEL, however, cannot be de-blocked by the acids formed upon photolytic decomposition of the photolytic acid generators as they are free of any acid cleavable groups.

In a further embodiment, of the invention which relates to the aspect of photolytic acid generators, an optional refinement may be accomplished by adding alkaline additives to the photosensitive coating material for forming the BCEL. The alkaline additives, also called quenchers, diffuse out of the coating into the adjacent resist film and lead to a reduction or neutralization of possible acid concentrations in un- or less exposed regions of the resist, while there is only a moderate reduction in exposed areas, due to the simultaneously diffusing acids.

In any case, the outdiffusion of alkaline additives leads to a neutralization, or quenching, of acids generated in the photosensitive resist film or diffused into photoinsensitive resist films during an exposure. Due to the finite diffusion length, the quenching occurs in a region near the contact surface between the resist film and the photosensitive coating of the BCEL, i.e., in a bottom region of the resist film.

It is preferred that both the BCEL underneath the resist film and the above mentioned contrast enhancing layer, which is located on the resist film are used in conjunction with the resist film for the exposure of the resist film and that these layers are formed adjacent to each other, i.e., they are in direct contact with each other. In particular the BCEL can be in direct contact with a lower surface of the resist film and the contrast enhancing layer can be in direct contact with an upper surface of the resist film, so that the resist film is sandwiched between the BCEL and the contrast enhancing layer. Both the photosensitive resist film as well as the above mentioned photoinsensitive resist film can be used in conjunction with the BCEL and the contrast enhancing layer.

Further, dark side lobes or dark SRAFs printing in the resist frequently develop near the bottom surface of the resist film due to absorption of light within the resist. Additionally, the diffusion length of the acid and alkaline molecules is too short to completely penetrate the resist film. Consequently, the use of the BCEL as a bottom coat is preferred. In this case, the diffusing molecules may easily reach the (bottom) region, where printing of dark side lobes or dark SRAFs may often arise. Accordingly, one effect of preferred embodiments of the invention is that the chemical contrast in acid concentrations between exposed and unexposed regions in the resist is enhanced for both the regions of the resist film near the BCLE as well as for the regions of the resist film located near the top contrast enhancing layer. Another effect is that the level of acid concentration in a bottom region of the resist film is increased with respect to a top surface region. As the optical contrast correlates with the contrast in acid concentration, the invention works as if the optical contrast had been enhanced and as if the strong absorption towards the resist bottom is decreased.

In a further aspect the BCEL is arranged to function as a bottom anti-reflective layer (BARC). Therein, the refractive indices of the BCEL are adapted to range between that of the overlying resist film and that of the underlying material layer, such that the reflection at the surface boundaries is reduced, just as in conventional antireflection techniques, e.g., with a refractive index n close to that of the resist (for example: n_{(BCEL)}=n₍ᵣₑₛᵢₛₜ₎±0.2) and an absorption coefficient ranging from, e.g., 0.5 to 2.0 μm⁻¹.

With regard to the base polymer and the solvents, the photosensitive coating for forming the BCEL is not limited to the specific embodiments presented herein and a person skilled in the art will readily recognize that similar materials having the substantially same effect can be exploited as well.

For example, the photosensitive coating material to be disposed as a BCEL may, according to an embodiment, include a base polymer, which is based on an acryl or vinyl polymer platform. Examples are polyethers, polyesters, polyurethanes, dye attached polysaccharides, polymerblends with additional Styrene-monomers, etc. The acryl or vinyl polymers may be attached with light absorbing dyes. They may further be adapted to be crosslinkable.

Alternately, novolaks, cresol-novolaks, polyhydroxystyrene, among others, which advantageously might be crosslinkable may be employed for the base polymer of the photosensitive coating material and the BCEL, according to further embodiments of the invention.

Crosslinkers may, according to an embodiment, be added, which are of the melamine or urea type. Also, secondary or tertiary alcohols are possible.

As a solvent, common resist solvents, such as for example, methoxypropylacetate, ethyllactate, cyclohexanone, cyclopentanone, γ-butyrolactone, propylene glycol monomethyl ether acetate (PGMEA), propylene glycol monomethyl ether (PGME), etc., may be used according to further embodiments.

A further important aspect of the photosensitive coating to be disposed as a BCEL relates to a combination of a thermo acid generator with a photodecomposable alkaline additive within the same coating. The thermo acid generator is arranged to release an acid, when its temperature is increased beyond a threshold level, particularly during a bake step. For example, the thermo acid generator may be a benzylthiolanium or benzyldithiolanium compound of sulfonic acids. In a particular embodiment, the thermo acid generator is one of benzylthiolanium hexafluorpropanesulfonate or benzyldithiolanium hexafluorpropanesulfonate. Preferably the amount of thermo acid generator is smaller than the amount of alkaline additive and the amount of possible photolytic acid generators in the BCEL in order not to counteract the effect of contrast enhancement provided by the alkaline additives and the photolytic acid generators.

Further embodiments relate to the aspect of a photolytic acid generator (PAG) used in the photosensitive coating for forming the BCEL or the top contrast enhancing layer. The PAG may comprise triphenylsulphonium or diphenyliodonium salts of strong sulphonic acids, which are also called crivello salts. For example, triphenylsulphonium-nonafluorbutanesulphonate or diphenyliodonium-p-toluolsulphonate may be used as the photolytic acid generator.

In an alternate embodiment, N,O-sulfonic acid esters, o-nitrobenzylic acids, diazonaphtoquinonesulfonates (DNQ), AsF₆ or SbF₆ may be used with regard to the PAG. Therein the N,O-sulfonic acid esters may be, for example, phtalimidotosylates or related sulphonic nitrogen bound esters of phthalimides.

In case a quencher or alkaline additive is added to the PAG, which is not photodecomposable, the alkaline additive may be associated with a first pKa value, which is larger than a second pKa-value provided by the adjacent resist. The alkaline additive may be an anorganic base, or alternatively, an organic base such as an amine. For example, the alkaline additive may be provided by trialkylamines or trialcohol amines. More precisely, the alkaline additive may be represented by trioctylamines or triethanolamines. The alkaline additive may further be tetramethylammonium acetate, etc. It goes without saying that a person skilled in the art and carrying out the prescriptions as enclosed herein may also consider other suitable photodecomposable alkaline materials.

It is noted, that—with regard to tetramethylammonium acetate—the term “alkaline additive,” which is to be considered throughout this document as a relative quantity with respect to acids generally contained in the adjacent resist, may also include weak acids, e.g., carbonic acids (e.g., carboxylate being added), acetic acids, salicylic acids, etc.

In the case that both the BCEL and the top contrast enhancing layer are used in methods of certain embodiments of the invention, it might be advantageous to use an alternating electrical field in the case that polar or charged acids are formed via the decomposition of the photolytic acid generators in the respective layers in order to directionally diffuse these acids from both the BCEL and the top contrast enhancing layer into the resist film sandwiched in between both layers. The alternating electrical field might have a voltage of 50 V to 8000 V at a frequency of 0.01 Hz to 5000 Hz. Preferably the alternating field might be applied during the above mentioned post exposure bake step.

The photosensitive resist and the photoinsensitive resist film might both for example comprise the following polymers, which can also be combined in the form of copolymers, comprising repeating units of different polymers, which are covalently linked or in the form of polymer blends, wherein two or more different polymers are mixed together (T-Bu=tert-Butyl-group; Ad=Adamantyl-group or —O-Adamantyl or Me-Adamantyl). These polymers all contain acid-cleavable ester groups as acid-sensitive groups, which can be cleaved by the acids generated upon exposure of the photolytic acid generators: 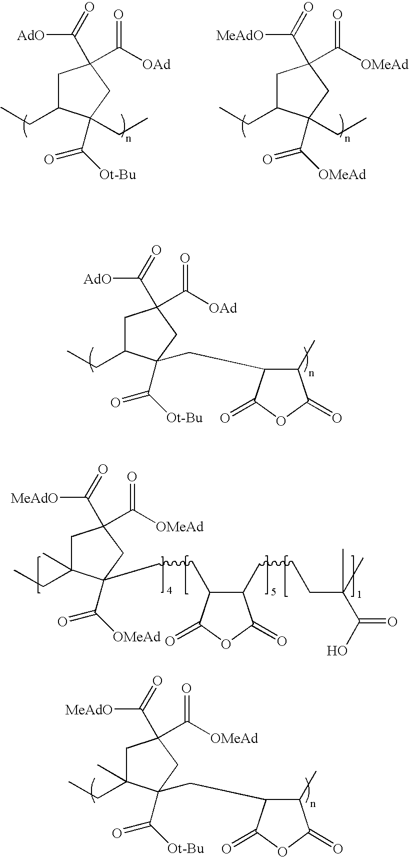
The indices n might be selected in such a way to obtain polymers with average molecular weights of 1000 to 10 000 g/mol.

Polycarboranes with the following structures: 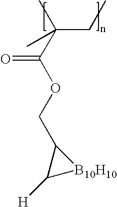
Wherein the index n might be selected in such a way to obtain polymers with average molecular weights of 500 to 6000 g/mol, and B₁₀H₁₀ denotes the following group: 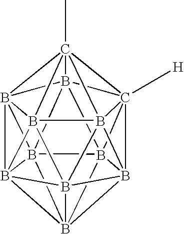
The polymers also might comprise silsesquioxanes of the following structure: 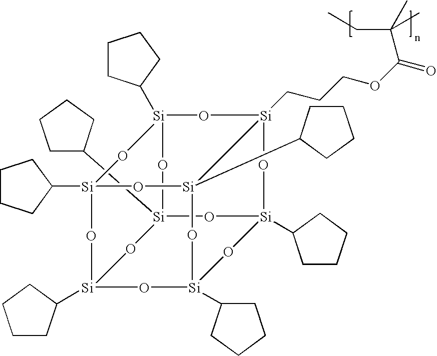
Wherein the index n might be selected in such a way to obtain polymers with average molecular weights of 500 to 12 000 g/mol.

The polymers also might comprise the following structures: 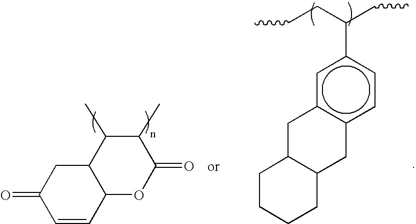
Wherein might be selected in such a way to obtain polymers with average molecular weights of 500 to 12 000 g/mol.

A further embodiment of the method of the invention is related to a method of exposing a semiconductor wafer, the method comprising the method steps of:

A) Applying a resist to the semiconductor wafer to form a resist film, the resist film comprising:
a resist base polymer;

B) Applying a first photosensitive coating material to said semiconductor wafer to form a first contrast enhancing layer (CEL) upon the resist film, said first contrast enhancing layer comprising a first CEL base polymer, a first alkaline additive and a first photoactive component;

C) Exposing that first contrast enhancing layer and the underlying resist within a first portion with optical light, UV-radiation, x-ray radiation, electrons, charged particles or ion projection lithography, wherein:
a concentration of the first alkaline additives in first exposed portions of the first contrast enhancing layer is reduced or neutralized due to the exposure of the first photoactive component, and
a concentration of acids in first exposed portions of the resist film is increased;
diffusing the first alkaline additive remaining in unexposed portions of the first contrast enhancing layer into a surface region of the adjacent resist film to increase the contrast in acid concentration between first exposed and unexposed portions therein; and

D) developing the resist film to remove either exposed or unexposed portions thereof.

As mentioned above such an embodiment of the method of the invention is able to enhance the contrast between first exposed portions of the resist film and unexposed portions of the resist film due to the fact that concentration of the first alkaline additives in the unexposed portions in the resist film is enhanced due to the diffusion of the first alkaline additives from the contrast enhancing layer into the resist film and due to the fact that the concentration of acids in the first exposed regions of the resist film is enhanced due to diffusion of acids into these regions.

A further advantageous embodiment of a method of the invention also comprises the further method step of:

A1) Prior to method step A) applying at third photosensitive coating material to said semiconductor wafer to form a bottom contrast enhancing layer (BCEL) on the semiconductor wafer, said bottom contrast enhancing layer comprises a third BCEL base polymer, which is free of any acid-sensitive groups, a third alkaline additive and a third photoactive component,

wherein in method step A) the resist film is formed on the bottom contrast enhancing layer.

As mentioned above, such a bottom contrast enhancing layer can also enhance the contrast between exposed and unexposed portions of the resist film in the bottom areas of the resist film due to the diffusion of acids from the photoactive components and the third alkaline additives into the resist film.

The third photoactive component in another embodiment of the invention can comprise a third photolytic acid generator wherein the acids generated by the photolytic decomposition of the third photolytic generator can diffuse into the exposed portions of the resist film thereby enhancing the contrast between exposed and unexposed portions at least in the bottom regions of the resist film.

A further advantageous embodiment of the method of the invention further comprises the modification that the step of diffusing the first alkaline additive into the resist is performed in a method step C1) after step C) by means of a first post-exposure bake step.

As mentioned above such a first post-exposure bake step has the advantage that the diffusion of the alkaline additives is enhanced due to the heating of the resist film and the contrast enhancing layer and/or the bottom contrast enhancing layer. In the case that acids are released from a photolytic acid generator from the bottom contrast enhancing layer and/or the contrast enhancing layer on top of the resist film, these acids also can diffuse into the exposed portions of the resist film during the first post exposure bake step.

Yet another embodiment of a method of the invention comprises the use of a resist film, which is photoinsensitive and wherein the resist base polymer includes acid-sensitive functional groups, and wherein during exposure of said first contrast enhancing layer and underlying resist the concentration of acids in exposed portions of the resist film is increased due to the diffusion of the acids formed from the first photoactive component of the contrast enhancing layer into the adjacent resist film, reacting with the acid-sensitive functional groups of the resist film.

As mentioned above, it is possible to design high resolution resist films with good etch resistance, which are not photosensitive, due to the fact that the acid required for the cleavage of the acid sensitive functional groups is delivered by the contrast enhancing layer on top of the resist film and/or by the bottom contrast enhancing layer on which the resist film is located. These photoinsensitive resist films are advantageously free of any photolytic acid generators.

A further embodiment of a method of the invention comprises a so-called double exposure lithography technique further comprising the method steps of:

C2) After method steps C) or C1) removing the first contrast enhancing layer;

C3) Applying a second photosensitive coating material to said semiconductor wafer to form a second contrast enhancing layer (CEL) upon the resist, said second contrast enhancing layer comprising a second CEL base polymer, a second alkaline additive and a second photoactive component;

C4) Exposing said second contrast enhancing layer and the underlying resist film within a second exposed portion with optic light, UV-radiation, x-ray radiation, electrons, charged particles, or ion projection lithography, wherein:
a concentration of the second alkaline additives in second exposed portions of the second contrast enhancing layer is reduced or neutralized due to the exposure of the second photoactive component; and
a concentration of acids in second exposed portions of the resist film is increased, and
diffusing the second alkaline additive remaining in unexposed portions of the second contrast enhancing layer into a surface region of the adjacent resist film to increase the contrast in acid concentration between second exposed and unexposed portions therein.

One problem of photolithographic techniques is that they have a resolution limit, which further has to be decreased in order to be able to create structures with increasingly smaller dimensions in the resist films and transferring these increasingly smaller structures into semiconductor wafers or layers to be structured. The above-disclosed double exposure lithography technique can, for example, be used to increase the resolution of the photolitho-graphic processes. For example a plurality of first structures can be created in a resist film wherein the distance between two neighboring first structures is at the resolution limit of this first lithographic process. In a second exposure step using a second contrast enhancing layer on top of the resist film second structures can be created and formed within the resist film wherein the distance between two neighboring second structures is again at the resolution limit of this second lithographic process. In this case wherein the second exposure step was also carried out at the resolution limit of the photolithography technique, a combined structure pattern comprising the first and second structures is formed in the resist film, which results in an enhancement of the resolution limit by the factor of two. In a further embodiment of the method of the invention, the second structures can be interspersed between the first structures and are for example comb-like arranged between the first structures so that a superposition of the first and second structures results in superposition structure wherein a first structure is adjacent to a second structure (see for example FIG. 13E).

The above-mentioned double exposure lithography technique using a first and a second contrast enhancing layer on top of a resist film to be structured in two separate lithographic exposure steps can be carried out with the above-mentioned bottom contrast enhancing layer or without it. In addition more than two separate exposure steps with even more than two contrast enhancing layers (for example three or four contrast enhancing layers used for three or four separate exposure steps) are also within the scope of the present invention.

A further advantageous embodiment of the double exposure lithography technique is provided wherein during the method steps C) and C4), the first and second exposed portions for the two separate exposure steps are chosen in such a way that these first and second portions are dislocated relative to each other in the resist film. Preferably the distance of two neighboring first exposed portions of the resist films or two neighboring second exposed portions in the resist film is larger than the distance of a first exposed portion to a neighboring second exposed portion in the resist in order to increase the resolution achieved by each separate exposure step C) or C4). It is also possible to create other structures in the resist film via superposition of the first and second structures created in the separate exposure steps.

Advantageously a post-exposure step can be carried out after the first and second exposure of the first and second contrast enhancing layer in order to accelerate the diffusion of acids and alkaline additives formed in the first and second contrast enhancing layer into the resist film to be structured. An electrical field can be applied during the post exposure bake steps in order to accelerate the diffusion of acids and alkaline additives from the contrast enhancing layers into the resist film beneath. In the case that also a bottom contrast enhancing layer is used in the double exposure lithography technique an alternating electrical field can be applied during the both post-exposure bake steps in order to directionally diffuse also the acids formed by the photolytic acid generators in the BCL into the bottom regions of the resist film to be structured.

Further advantageous aspects and embodiments are evident from the appended claims and drawings.

### BRIEF DESCRIPTION OF THE DRAWINGS

Other features and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs.

FIG. 1, consisting of FIGS. 1A and 1B, shows different embodiments of a photosensitive coating serving as a contrast-enhancing layer applied to a resist film on a substrate;

FIGS. 2-5 show a sequence of cross-sectional profiles through the photosensitive bi-layer coating shown in FIG. 1A with respect to different method steps according to an embodiment of the invention;

FIGS. 6-9 show the resulting profiles of the base or acid concentration as a function of the x-coordinate corresponding to the profiles shown in FIGS. 2-4;

FIG. 10 shows a profile of base or acid concentration with respect to a second embodiment, wherein the suppression of side lobes is illustrated;

FIG. 11 shows a third embodiment similar to FIG. 10, wherein different exposure conditions are applied, which conventionally would lead to the occurrence of side lobes;

FIGS. 12A to 12D show an embodiment of a method according to the invention, wherein a BCEL and a top contrast enhancing layer are both used in conjunction in order to expose a resist film to radiation and create a pattern of structures therein;

FIGS. 13A to 13F show a further embodiment of a method of the invention using a double exposure lithography technique for a resist film in conjunction with a BCEL and a top contrast enhancing layer; and

FIGS. 14A to 14C denote the results of a simulation of a double exposure lithography technique using the program “Solid C+”.

The following list of reference symbols can be used in conjunction with the figures:

| | | | |
|---|---|---|---|
| 10 | substrate | | surface region in resist film, available for |
| 12 | layer on substrate, to be structured | | diffusion |
| | by lithographic patterning | 22 | exposed region in CEL |
| 14 | resist film | 24 | unexposed region in CEL or first |
| 14′ | resist mask | | exposed region in first CEL |
| 142 | bottom resist | 32 | (first) exposed region in resist film |
| 144 | top resist | 34 | unexposed region in resist film |
| 16 | (first) photosensitive coating, | 40 | exposure light beam |
| | contrast enhancing layer (CEL) | 50 | etch step |
| 16A | second contrast enhancing layer | 22A | second exposed region in second CEL |
| 60 | bottom contrast enhancing layer | 32A | second exposed regions in resist film |
| 65 | alternating electrical field | 130 | alkaline additive concentration in CEL |
| 100 | first structures in resist film | | after exposure |
| 100A | second structures in resist film | 130A | alkaline additive concentration in CEL |
| 110 | photoacid concentration in CEL after | | after neutralization |
| | exposure | 140 | degree of deprotection |
| 110 A | photoacid concentration in CEL | 150 | superposition of the photoacid |
| | after neutralization | | concentration in first and second CEL |
| 120 | target resist profile | | |

### DETAILED DESCRIPTION OF ILLUSTRATIVE EMBODIMENTS

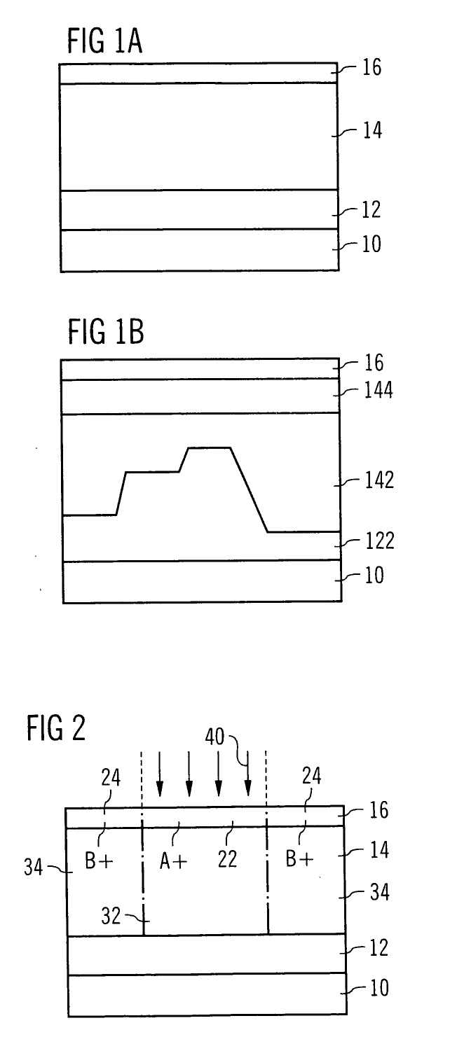

In FIG. 1 different embodiments of a photosensitive coating serving as a contrast-enhancing layer are shown. FIG. 1A shows a case wherein a layer 12 of a material to be structured (etched) such as an oxide, a nitride, a metal, polysilicon, etc., is deposited on a substrate 10, which may refer to monocrystalline silicon. A resist film 14 is spun on the layer 12. The resist film 14 is formed of any conventionally known type of resist material, e.g., positive or negative, Novolak-based, chemically amplified, etc.

Further, a photosensitive coating 16 is applied upon the resist film 14. This coating 16 comprises a water-soluble base polymer, e.g., a polyacrylic acid, a photolytic acid generator, e.g., a Triphenylsulphonium salt, and an alkaline additive, e.g., Trioctylamine. In order to deposit the coating 16 upon the resist film 14, the ingredients as described above are dissolved in a solvent, which is a mixture of water and isopropanole according to this embodiment. This coating material is spun on the substrate 10 including layer 12 covered with the resist film 14. A pre-bake step is performed to dry the still semi-liquid coating material.

The resist material comprises a base polymer considered to be soluble with respect to Methoxypropylacetate, Ethayllactate, Cyclohexanone, Cyclopentanone, γ-Butyrolacton, Ethylacetate, etc., such that it may not be dissolved by the top coating 16 of the contrast enhancing layer. The top coating 16 has a thickness in the range 30-250 nm, while the resist film 14 has a thickness of 50 to 400 nm.

FIG. 1B shows a second embodiment with a photosensitive coating 16 disposed on a first resist film 144. This resist film is part of a bi-layer resist, wherein this upper layer refers to a top resist, which is a chemically amplified resist (CAR). A second bottom resist 142 merely serves to compensate a surface topography due to one or more layers 122 to be structured by means of an etch applied to the substrate using the developed resist as a mask.

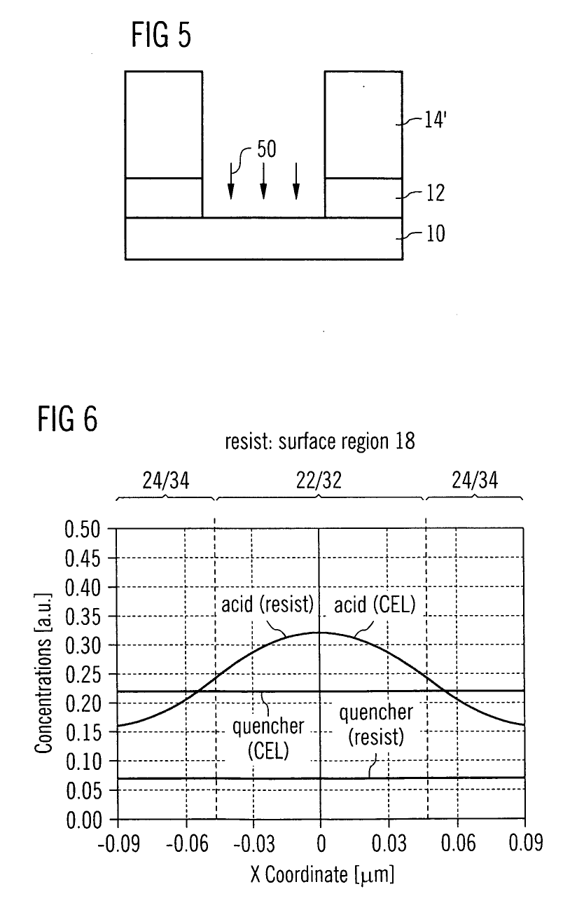

FIGS. 2-5 illustrate a method of processing the resist according to embodiments of the invention, which starts from the situation as displayed in FIG. 1A. With regard to FIG. 2, an exposure light beam 40 having a wavelength of, e.g., 193 nm (DUV, deep ultraviolet) impinges on the photosensitive coating to form an exposed region 22 therein, further leaving regions 24 unexposed. The exposure light beam 40 may be generated by means of a mask or reticle arranged within the optical path of light in a corresponding exposure tool.

As the photosensitive coating 16 has an absorption coefficient k of less than 0.05 and a thickness of less than 100 nm, the coating is nearly transparent and the beam 40 reaches into the resist film 14 forming an exposed region 32 therein. The resist also comprises a base polymer and photolytic acid generators, however, the resist film 14 lacks a base additive when compared with the top coating 16.

Alkaline molecules (quenchers, indicated by “B+” in the figures) are initially present over the whole surface area of the top coating 16, but are neutralized by the acids currently generated in the exposed region 22, as indicated by an “A+”. Accordingly, the exposed region 22 is mainly acid while the unexposed regions 24 are mainly alkaline. The resulting concentrations (in arbitrary units) are schematically depicted in FIG. 6 as a function of x-coordinate.

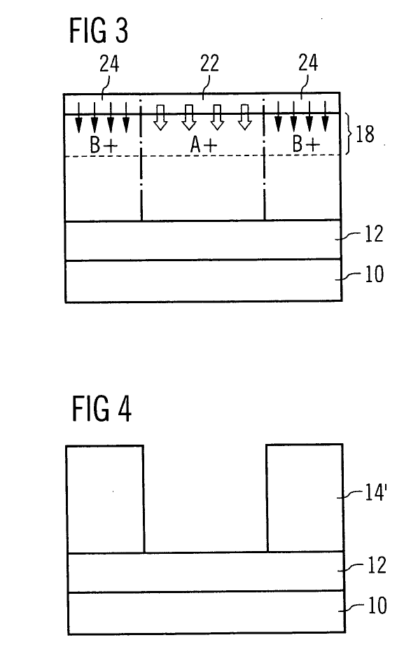

FIG. 3 shows further development of the process during performance of a post-exposure bake. The temperature applied provokes outdiffusion of the acids and alkaline molecules (quenchers) into the adjacent resist film, respectively. The diffusion length is limited such that only a surface region 18 of the resist film 14 is affected by diffusion. Loss of acids generated in the resist film 14 may also occur by means of diffusion into the top coating 16. It is further noted that the individual diffusion lengths of the acids and the quenchers may be different such that vertical concentration profiles may follow.

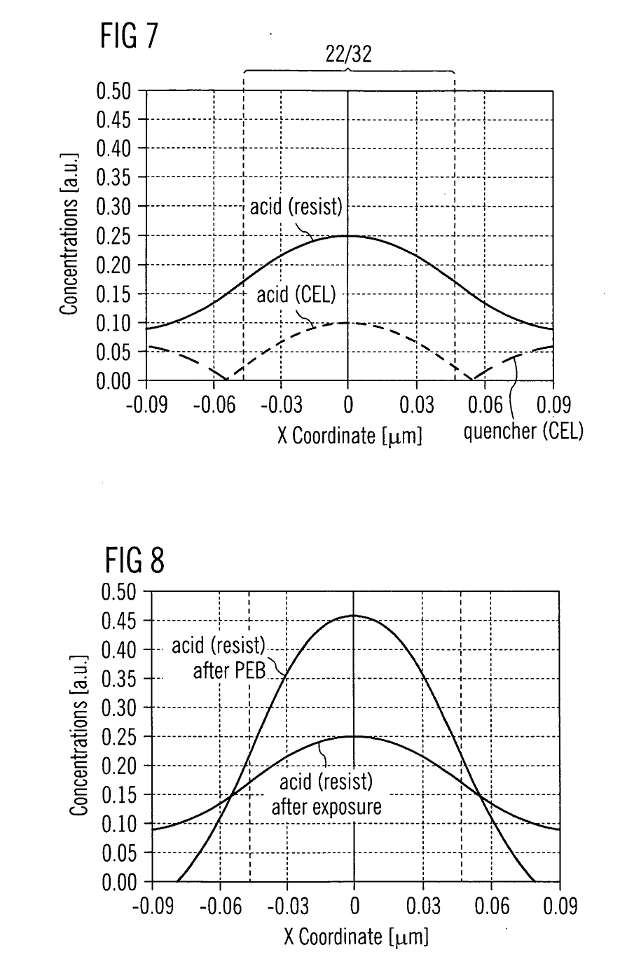

As a result of the diffusion, the quencher concentration B+ in the unexposed region 34 in the resist film increases and the minor acid concentration is neutralized. On the contrary, the acid concentration A+ in the exposed region 32 of the resist film 14 increases, which is shown in the diagrams of FIGS. 7 and 8. FIG. 7 shows an imaginary step according to this simplified embodiment, wherein the acid concentration profile in the resist film 14 has been reduced by the concentration of quenchers already present within the resist surface region 18. The dashed curves show the remaining concentrations of acids and quenchers within the photosensitive coating 16, denoted “CEL” in FIGS. 6-11.

FIG. 8 shows the result after the diffusion step, i.e., adding the acid concentrations (exposure region 32) and subtracting quencher concentrations from acid concentrations (unexposed regions 34). It is clearly visible that the concentration profile of acids in the resist is steepened, or the contrast is enhanced.

Returning to the process of lithographically structuring the substrate, FIG. 4 displays the situation after the photosensitive coating 16 (exposed and unexposed regions) and the resist film 14 (exposed region only) have been developed using, e.g., a conventional TMAH developer: 2.38% Tetramethylammoniumhydroxide (TMAH) dissolved in water and additives. Unexposed portions of the resist remain as a resist mask 14′. An etch process 50 may then be performed to transfer the exposed structure from the resist (resist mask 14′) into the layer 12.

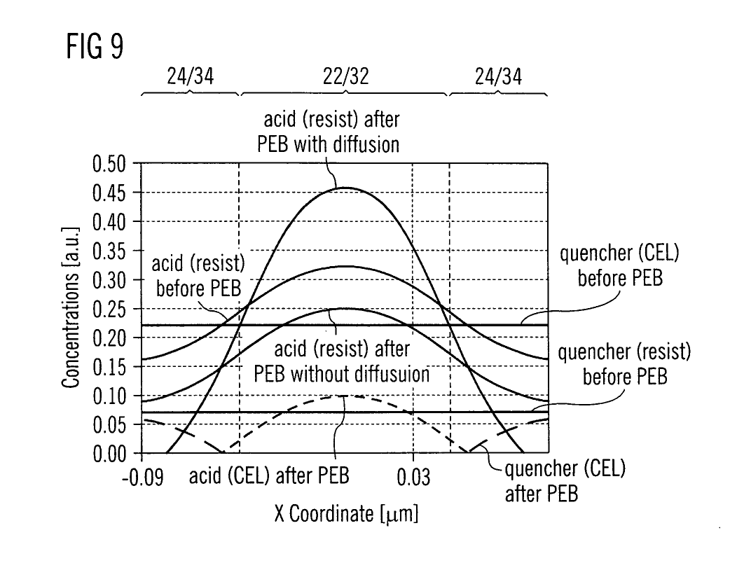

FIG. 9 provides an overview of the concentrations of acids and quenchers achieved in the individual steps displayed in the foregoing. The concentration profiles relate to an exposure of a wafer using a halftone mask with 6% attenuation, comprising a 90 nm lines and spaces pattern (widths refer to wafer scale). The numerical aperture was 0.75, illumination was carried out with annular σ=0.55-0.85. A bottom antireflective coating was further used.

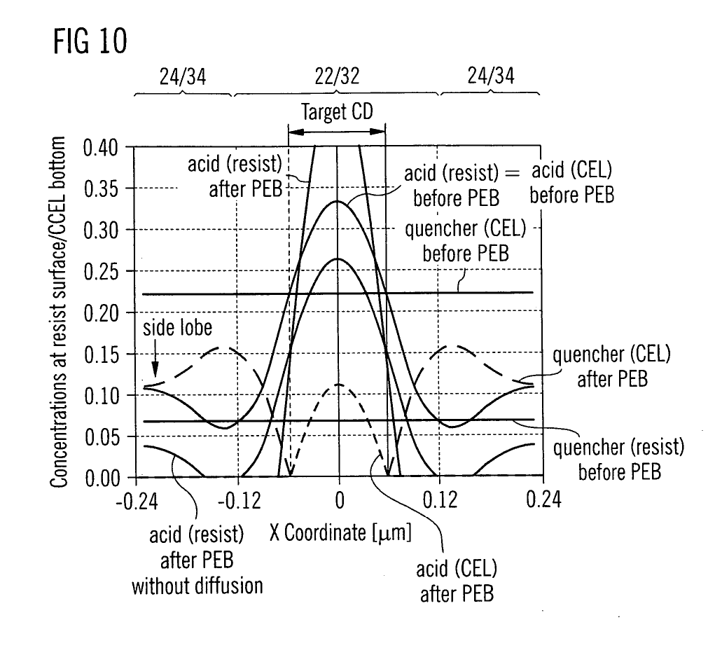

FIG. 10 shows for comparison a more challenging exposure condition, that illustrates the development of side lobes in the surface region 18 of the resist near the primarily exposed region 32. The illumination was circular with σ=0.5 while the other parameters were the same as in the example given above. It is clearly visible, that the occurrence of the side lobe extending at a distance of 150 to 180 nm from the main structure (“target”) is mitigated by means of a reduced acid concentration at that position.

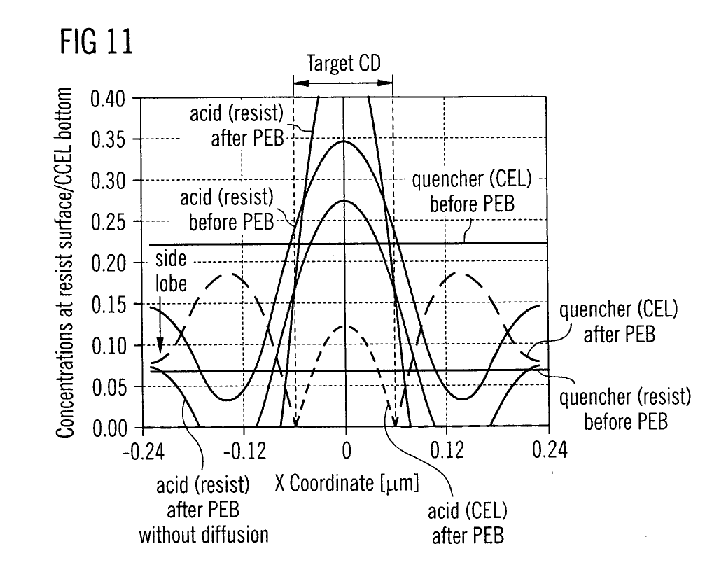

FIG. 11 shows an even more challenging exposure condition with an illumination σ=0.2, which may yield the occurrence of a side lobe in the resist effectively after a following development step. Applying the photosensitive coating 16 as a contrast enhancing layer according to this embodiment of the invention, the side lobe is similarly mitigated as in the previous example.

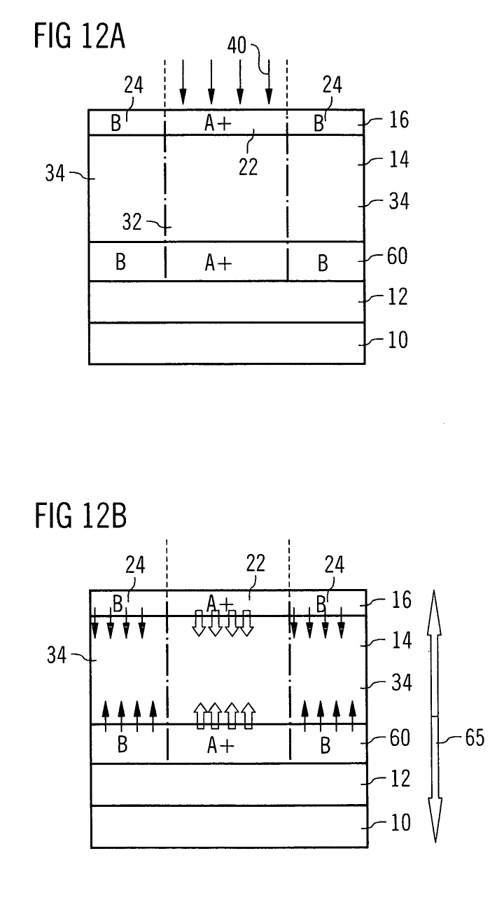

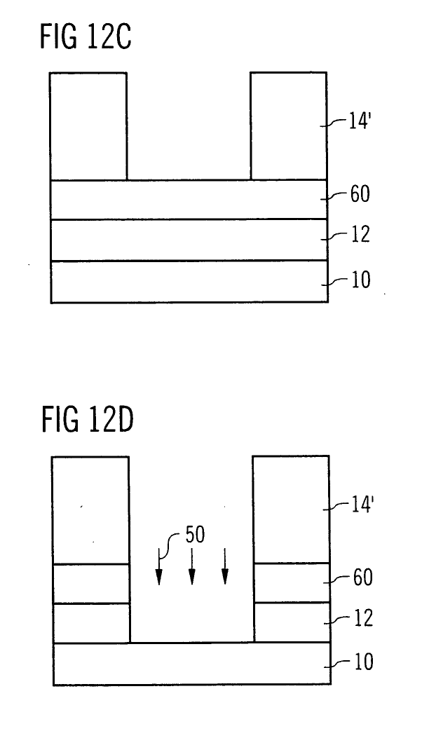

FIGS. 12A to 12B show one embodiment of a method of the invention. FIG. 12A shows a multilayer arrangement wherein a layer 12 to be structured by a photolithography technique is located on a substrate 10. A bottom contrast enhancing layer 60 is located on top of the layer 12 to be structured. A resist film 14 is located on the bottom contrast enhancement layer 60, wherein a contrast enhancing layer 16 is located on top of the photoresist film 14, so that the photoresist film 14 is sandwiched between the contrast enhancing layer 16 and the bottom contrast enhancing layer 60.

FIG. 12A denotes the method step C) of the above-mentioned method of the invention wherein an exposure light beam 40 is used to expose a first exposed region 22 in the contrast enhancement layer to a radiation, for example EUV radiation. Unexposed portions of the contrast enhancement layer 16 are denoted by the reference numeral 24. It can be seen in FIG. 12A that due to the photolytic decomposition of photolytic acid generators in the contrast enhancing layer 16 and the bottom contrast enhancing layer 60 photoacids A+ are generated in the first exposed regions. In contrast to that, alkaline additives B are mainly present in the unexposed regions of the contrast enhancing layer 16 and the bottom contrast enhancing layer 60. The resist film 14 has a certain transmittance for the exposure light beam 40 so that the bottom contrast enhancing layer 60 can be exposed to the radiation of the exposure light beam 40 through the resist film 14.

FIG. 12B denotes the method step C1) of the above-mentioned method of the invention wherein during a post-exposure bake step the acids A+ and the alkaline additives B both from the contrast enhancing layer 16 and the bottom contrast enhancing layer 60 diffuse into the unexposed portions 34 or the exposed portions of the resist film 14 (indicated by the arrows). An alternating electrical field 65 can be applied in order to increase the directional diffusion of the acids A+ from both the contrast enhancing layer 16 and the bottom contrast enhancing layer 60 into the exposed portions of the resist film 14.

The next FIG. 12C shows the method step D) of the above-mentioned method wherein the resist film 14 has been developed to form the resist mask film 14′. The resist mask film 14′ can now serve as a mask for the subsequent etch step of the layer 12 to be structured.

In the next FIG. 12D an etch step 50 is carried out wherein the structure of the resist mask film 14′ is transferred into the structure 12 to be patterned through the bottom contrast enhancing layer 60.

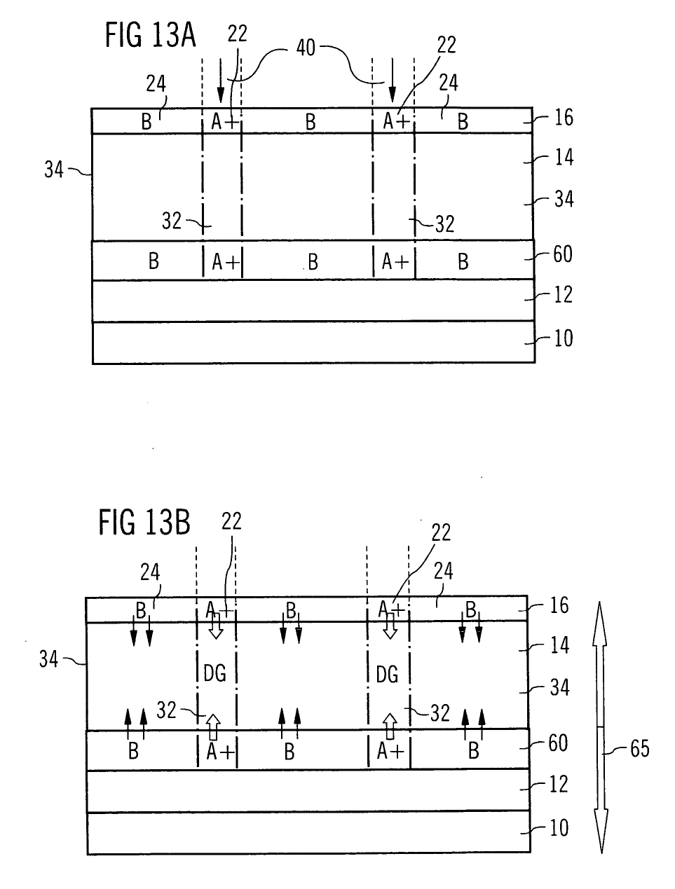

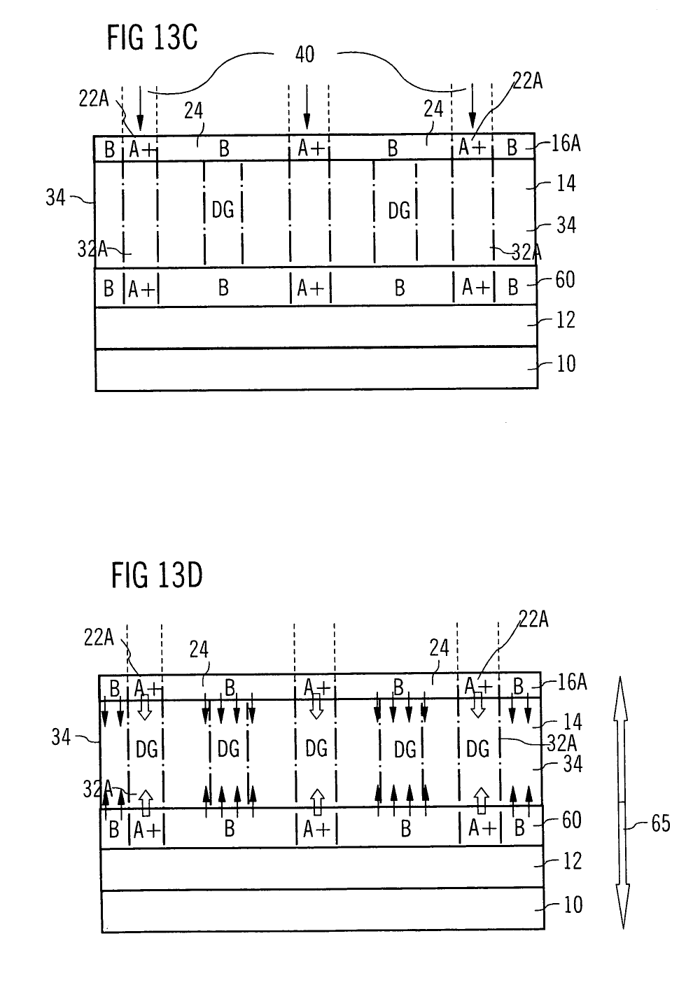

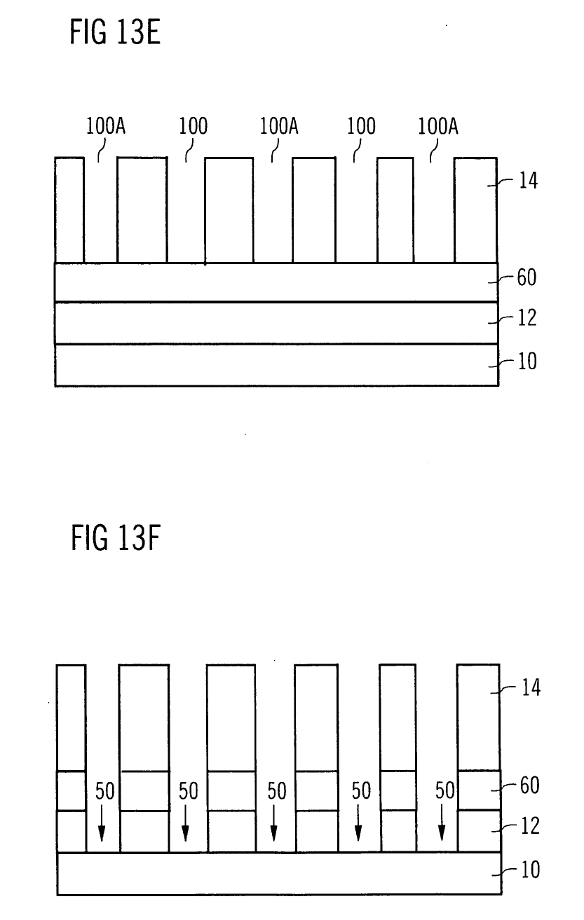

The FIGS. 13A to 13F depict one possible embodiment of a double exposure lithography technique according to the invention.

FIG. 13A shows a multilayer arrangement of a layer 12 to be structured, which is located on a substrate 10. A layer arrangement of a resist film 14 interspersed between a first contrast enhancing layer 16 on top and a bottom contrast enhancing layer 60 beneath is located on top of the layer 12 to be structured.

FIG. 13A shows the multilayer arrangement during step C), the exposure of the first contrast enhancing layer 16, the resist film 14 and the bottom contrast enhancing layer 60 with radiation, for example optic light, UV radiation, x-ray radiation, electrons, charged particles or during ion projection lithography. It can be seen that an exposure light beam 40 exposes first exposed regions 22 of the first contrast enhancing layer 16, thereby creating acids A+ via photolytic decomposition of photolytic acid generators, which are present in the first contrast enhancing layer 16. Again the resist film 14 shows a certain transmission for the exposure light beam 40 so that also the bottom contrast enhancing layer 60 can be exposed to the exposure light beam 40 through the resist film 14. As mentioned above alkaline additives B are mainly present in the unexposed regions 24 of the first contrast enhancing layer 16 and also in unexposed portions of the bottom contrast enhancing layer 60.

FIG. 13B shows a first post-exposure bake step C1) wherein in addition to heating the layer arrangement, an alternating electrical field 65 is applied in order to directionally diffuse the acids A+ formed in both the first contrast enhancing layer 16 and the bottom contrast enhancing layer 60 into the first exposed portions 32 of the resist film (indicated by arrows). Due to the fact that the resist film includes acid-sensitive groups which can be de-protected via acid-catalyzed cleavage de-protected groups DG are formed in the first exposed regions 32 of the resist film 14. The resist film 14 can comprise a photosensitive or a photoinsensitive resist film as mentioned above.

The next FIG. 13C shows the multilayer arrangement after the above-mentioned method steps C2) and C3 have been carried out, namely the removal of the first contrast enhancing layer 16 and wherein a second photosensitive coating material was applied to the resist film 14 to form a second contrast enhancing layer 16A. FIG. 13C shows the new multilayer arrangement during the method step C4) namely the exposure of the second contrast enhancing layer 16A and the underlying resist film 14 within second exposed regions 22A of the second contrast enhancing layer 16A and second exposed portions 32A of the resist film 14. The resist film 14 already comprises first exposed regions from the first exposure step mentioned above wherein due to the acids the acid-sensitive groups of the resist film 14 are de-protected indicated by “DG”, so that a latent image is formed in the first exposed regions of the resist film 14. It is possible that optionally a neutralization bake was carried out before removing the first contrast enhancing layer 16 in order to completely neutralize the acid formed during the first exposure step C). Such a neutralization bake step could be carried out at temperatures lower than the post-exposure bake steps, for example at temperatures below 50° C. It is also possible that the resist film can comprise a quencher base, for example amines, which are supposed to quench the acid released by the photolytic acid generators.

During the second exposure step C4) shown in FIG. 13C an exposure light beam 40 is directed onto the second exposed regions 22A of the second contrast enhancing layer 16A thereby increasing the acid concentration in the second exposed regions of the second contrast enhancing layer 16A and also in the second exposed regions of the bottom contrast enhancing layer 60. Such an exposure of the bottom contrast enhancing layer 60 is primarily possible in the case that the resist film 14 on top of the bottom contrast enhancing layer 60 acts as a so-called optical contrast enhancing layer itself which means that the resist film 14 shows a certain transmittance for the exposure light beam 40 and can be further bleached by the exposure light beam at certain intensities, thereby increasing the transmittance of the resist film 14 for the exposure light beam.

FIG. 13D depicts the second post-exposure bake step after the second exposure step C4). Again it is possible to apply an alternating electrical field 65 in order to directionally diffuse the acids A+ formed in the second contrast enhancing layer 16A and in the second exposed portions of the bottom contrast enhancing layer 60 into the second exposed portions 32A of the resist film 14. As shown in FIG. 13D again an acid-catalyzed cleavage of the acid-sensitive group takes place resulting in de-protected groups DG in the second exposed portions 32A of the resist film 14. Again it is possible that some alkaline additives B still present in the bottom contrast enhancing layer 60 can diffuse into the unexposed regions of the resist film 40 during the second post-exposure step. This diffusion of alkaline additives might however occur to a lower extent when compared to step C1) the first post exposure bake step.

FIG. 13E shows the multilayer arrangement of FIG. 13D after the second contrast enhancing layer 16 has been removed and after the first structures 100 in the resist film 14 and the second structures 100A in the resist film, which both resulted from the first and second exposure step are developed, for example using an alkaline aqueous developer solution. The resist film 14 with the first structures 100 and the second structures 100A contains a high resolution structure because the distance between a first structure 100 and a neighboring second structure 100A is half the dimension of the maximum resolution for each separate exposure step (“pitch splitting”). As mentioned above, the bottom contrast enhancing layer 60 is normally free of acid-sensitive groups so that normally no latent image in the form of de-protected groups is formed in the bottom contrast enhancing layer 60 so that the bottom contrast enhancing layer 60 cannot be developed during the developing step.

FIG. 13F shows a subsequent etch step 50 wherein the first and second structures 100 and 100A of the photoresist film 14 are transferred into the layer 12 to be structured through the bottom contrast enhancing layer 60.

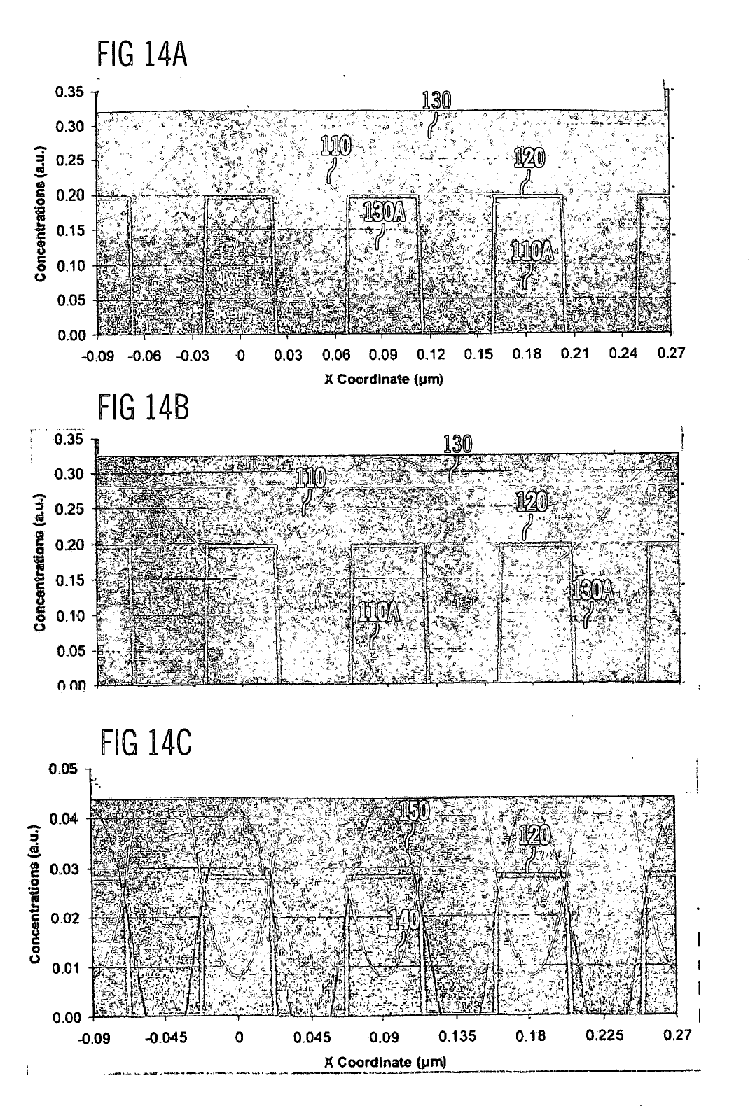

The FIGS. 14A to 14C show a graphical representation of the results of a simulation of a double exposure lithography with a first and second contrast enhancing layer on top of a resist film without a bottom contrast enhancing layer using the software “Solid-C+” with the parameters for dense line spaces: 90 nml/s; λ=193 nm; NA=0.75; σ=annular 0.55i0.85o; 360 nm resist/BARC. FIG. 14A shows the situation after the first exposure and neutralization step, whereas FIG. 14B shows the situation after the second exposure and neutralization step. FIG. 14C shows the superposition of the acid concentration of both the first and second exposure step and the amount of de-protection of acid-sensitive groups in the resist film resulting from that acid concentration. The reference numeral 120 denotes a target profile of structures to be formed in the resist film. The graphs of the FIGS. 14A to 14B both show the concentration of the acids or alkaline additives in the contrast enhancing layer during the first and second exposure step and after neutralization bake steps in absorption units “a.u.”. In particular the graphs show the contrast enhancement for dense lines/spaces, the line denoted with the reference numeral 110 shows the photoacid concentration in the contrast enhancing layer after the first or second exposure step in FIGS. 14A and 14B. The line denoted with the reference numeral 110A shows the concentration of the acids after the respective neutralization step in FIGS. 14A and 14B. The line 130A denotes the concentration of the alkaline additives in the contrast enhancing layer after the respective neutralization bake steps in FIGS. 14A and 14B. It can be seen in both FIGS. 14A and 14B that after neutralization high concentrations of alkaline additives 130A coincide with low concentration of photoacids 110A and vice versa low concentration of alkaline additives 130A coincide with high concentrations of photoacids 110A after neutralization so that a contrast enhancement is achieved in the contrast enhancement layer and the resist film between exposed and unexposed portions. FIG. 14B shows the concentration of alkaline additives and photoacids in the second contrast enhancement layer after the second exposure step and after the subsequent neutralization step. It can be seen that in contrast to the situation shown in FIG. 14A the high concentration of photoacid 110 after exposure is displaced by half of a period when compared with the high concentrations of photoacid after the first exposure in FIG. 14A. It can be seen that a high concentration of photoacids 110A after neutralization coincides with a low concentration of alkaline additives 130A and vice versa, resulting in a contrast enhancement.

FIG. 14C shows the superposition 150 of the acid concentrations of first and second exposure steps wherein the line denoted 140 shows the de-protection of the acid-sensitive groups in the resist film for the first and second exposure steps, both high acid concentrations and the degree of deportection coinciding with the target resist profile 120 to be created.

The simulation therefore clearly shows that a contrast enhancement can be achieved using two separate exposure steps with two different contrast enhancement layers on top of a resist film.

Although the present invention and its advantages have been described in detail, it should be understood that various changes, substitutions and alterations can be made herein without departing from the spirit and scope of the invention as defined by the appended claims.

What is claimed is:

1. A photosensitive coating material for enhancing a contrast of a photolithographic exposure of a resist film formed on a substrate, the photosensitive coating material comprising:
a base polymer;
a solvent for facilitating deposition of the photosensitive coating material upon a surface adjacent to said resist to form a film thereupon;
an alkaline additive suited to diffuse into the adjacent resist; and
a photoactive component arranged to reduce or neutralize a concentration of the alkaline additive in portions of the photosensitive coating that are exposed with optical light, UV radiation, X-ray radiation, electrons, charged particles, or ion projection lithography.

2. The photosensitive coating according to claim 1, wherein
the photoactive component is a photolytic acid generator for releasing an acid under said exposure, said acid being suited to diffusion into the adjacent resist.

3. The photosensitive coating according to claim 1, wherein the photoactive component is provided by the alkaline additive, which is photodecomposable, wherein the alkaline additive is arranged to decompose to a non-alkaline, neutral compound within said portions of the photosensitive coating, which are exposed with optical light, UV radiation, X-ray radiation, electrons, charged particles, or ion projection lithography.

4. The photosensitive coating according to claim 3, wherein the alkaline additive contains Triphenylsulphonium acetate.

5. The photosensitive coating according to claim 1, wherein the base polymer is soluble with respect to the solvent, which comprises water, for enabling an exposure in dry, air-based exposure systems.

6. The photosensitive coating according to claim 1, wherein the base polymer is soluble with respect to a developer comprising Tetramethylammoniumhydroxide (TMAH) dissolved in water and additives, prior to and after an exposure of the coating material with optical light, UV or X-ray radiation or a particle beam.

7. The photosensitive coating according to claim 1, wherein the base polymer is soluble with respect to the solvent, which comprises a mixture of water and isopropanole, for enabling an exposure in an immersion-based exposure system.

8. The photosensitive coating according to claim 1, wherein the base polymer comprises carboxylic acid groups.

9. The photosensitive coating according to claim 1, wherein the base polymer comprises alcoholic functions.

10. The photosensitive coating according to claim 2, wherein the photolytic acid generator comprises a Crivello salt, ortho-Nitro-benzylcompounds, AsF₆ or SbF₆, Phthalimidotosylates or related sulphonic nitrogen bound esters of Phthalimides.

11. The photosensitive coating according to claim 10, wherein the Crivello salt is one of Triphenylsulphonium- or Diphenyliodonium-sulphonates.

12. The photosensitive coating according to claim 2, wherein the photolytic acid generator comprises Triphenylsulphonium-nonafluorbutanesulphonate.

13. The photosensitive coating according to claim 2, wherein the photolytic acid generator comprises Diphenyliodonium-p-Toluolsulphonate.

14. The photosensitive coating according to claim 1, wherein the alkaline additive is an organic amine.

15. The photosensitive coating according to claim 14, wherein the alkaline additive is at least one of Trialkylamine or Trialcohol amines.

16. The photosensitive coating according to according to claim 15, wherein the alkaline additive is a Trioctylamine or a Triethanolamine.

17. The photosensitive coating according to according to claim 1, wherein a composition of the base polymer, the photoactive component and the alkaline additive is arranged, such that the photosensitive coating is transparent to an incident light or particle beam having an absorption coefficient of less than 0.05, when the solvent is removed in a bake step.

18. The photosensitive coating according to according to claim 1, wherein a composition of the base polymer, the photoactive component and the alkaline additive is arranged such that the photosensitive coating has a refractive index of more than or equal to 1.0 and of less than or equal to 1.7.

19. The photosensitive coating according to according to claim 1, wherein a composition of the base polymer, the photoactive component and the alkaline additive is arranged such that portions of the photosensitive coating being exposed are selectively removable with respect to a TMAH developer solution.

20. The photosensitive coating according to according to claim 1, wherein a composition of the base polymer, the photoactive and the alkaline additive is arranged such that the photosensitive coating is completely removable with respect to a TMAH developer solution.

21. The photosensitive coating material according to claim 1, comprising 10 to 90 weight % of solvent, 1 to 30 weight % of base polymer, 0.2 to 10 weight % of the photoactive component and 0.02 to 1 weight % of the alkaline additive.

22. The photosensitive coating material according to claim 1, comprising 30 to 70 weight % of solvent, 5 to 15 weight % of base polymer, 0.5 to 3 weight % of the photoactive component and 0.02 to 0.3 weight % of the alkaline additive.

23. The photosensitive coating material according to claim 22, wherein the solvent comprises water and isopropanole, the base polymer comprises polyacrylic acid, the photoactive component comprises triphenylsulphonium-hexafluorpropanesulfonate and the alkaline additive comprises trioctylamine.

24. A multilayer coating disposed on a substrate prior to photolithographic exposure, the coating comprising:
at least one resist film; and
a contrast enhancing layer (CEL), which is deposited upon said resist film, the contrast enhancing layer comprising:
(a) a base polymer;
(b) an alkaline additive suited to diffuse into the resist film; and
(c) a photoactive component arranged to reduce or neutralize a concentration of the alkaline additives in portions of the contrast enhancing layer, which are exposed with said optical light, UV radiation, X-ray radiation, electrons, charged particles, or ion projection lithography.

25. The multilayer coating according to claim 24, wherein said photoactive component of the contrast enhancing layer comprises a photolytic acid generator for releasing an acid under said exposure, said acid being suited to diffuse into the adjacent resist film.

26. The multilayer coating according to claim 24, wherein the photoactive component of the contrast enhancing layer is provided by the alkaline additive, which is photodecomposable, wherein the alkaline additive is arranged to decompose to a non-alkaline, neutral compound within said portions of the contrast enhancing layer under said exposure.

27. The multilayer coating according to claim 24, wherein the resist film is a photosensitive chemically amplified resist film and said alkaline additive of the contrast enhancing layer is suited to diffuse into the resist film for locally reducing or neutralizing an acid concentration formed therein.

28. The multilayer coating according to claim 27, wherein said photoactive component of the contrast enhancing layer comprises a photolytic acid generator for releasing an acid under said exposure, said acid being suited to diffuse into the adjacent resist film for enhancing an acid concentration formed locally therein.

29. The multilayer coating according to claim 24, wherein the resist film is photoinsensitive and comprises a first base polymer including acid-sensitive functional groups.

30. The multilayer coating according to claim 24, further comprising a bottom resist film for compensating height differences of a surface topography of the substrate, said bottom resist film being disposed on the substrate below the chemically amplified resist film.

31. The multilayer coating according to claim 24, wherein the base polymer is soluble with respect to a solvent, which comprises water, for enabling an exposure in dry, air-based exposure systems.

32. The multilayer coating according to claim 24, wherein the base polymer is soluble with respect to a developer comprising Tetramethylammoniumhydroxide (TMAH) dissolved in water and additives, prior to and after an exposure of the contrast enhancing layer with optical light, UV radiation, X-ray radiation, electrons, charged particles, or ion projection lithography.

33. The multilayer coating according to claim 24, wherein the base polymer is soluble with respect to a solvent, which comprises a mixture of water and isopropanole, for enabling an exposure in an immersion-based exposure system.

34. The multilayer coating according to claim 24, wherein the base polymer comprises carboxylic acid groups.

35. The multilayer coating according to claim 24, wherein the base polymer comprises alcoholic functions.

36. The multilayer coating according to claim 24, wherein the photolytic acid generator comprises a Crivello salt, ortho-Nitro-benzylcompounds, AsF₆ or SbF₆, Phthalimidotosylates or related sulphonic nitrogen bound esters of Phthalimides.

37. The multilayer coating according to claim 36, wherein the Crivello salt is one of Triphenylsulphonium- or Diphenyliodonium-sulphonates.

38. The multilayer coating according to claim 24, wherein the photolytic acid generator comprises Triphenylsulphonium-nonafluorbutanesulphonate.

39. The multilayer coating according to claim 24, wherein the photolytic acid generator comprises Diphenyliodonium-p-Toluolsulphonate.

40. The multilayer coating according to claim 24, wherein the alkaline additive comprises an organic amine.

41. The multilayer coating according to claim 24, wherein the alkaline additive comprises at least one of Trialkylamine or Trialcohol amines.

42. The multilayer coating according to claim 24, wherein the alkaline additive comprises a Trioctylamine or a Triethanolamine.

43. The multilayer coating according to claim 24 in combination with said substrate, wherein the multiplayer coating is disposed on a surface of the substrate.

44. The multilayer coating according to claim 43, wherein said substrate comprises a photomask.

45. The multilayer coating according to claim 43, wherein said substrate comprises a semiconductor wafer.

46. The multilayer coating according to claim 43, wherein the surface is provided by a material layer, which is deposited on said substrate.

47. The multilayer coating according to claim 21, further comprising:
a bottom contrast enhancing layer (BCEL), which is beneath said resist film, the bottom contrast enhancing layer comprising:
(a) a third BCEL base polymer, which is free of any acid-sensitive groups;
(b) a third alkaline additive suited to diffuse into the resist film; and
(c) a third photoactive component arranged to reduce or neutralize a concentration of the third alkaline additive in portions of the bottom contrast enhancing layer, which are exposed with said optical light, UV radiation, X-ray radiation, electrons, charged particles, or ion projection lithography.

48. A method of manufacturing a photosensitive coating material for photolithographic exposure of a resist film, wherein the photosensitive coating material is to be deposited on top of the resist film, the method comprising:
providing a coating material that includes:
a base polymer;
a photoactive component arranged to reduce or neutralize a concentration of the alkaline additives in portions of the photosensitive coating, which are exposed with optical light, UV radiation, X-ray radiation, electrons, charged particles, or ion projection lithography; and
an alkaline additive suited to diffusion into an adjacently arranged resist; and
dissolving the base polymer, the photoactive component and the alkaline additive in a solvent for facilitating deposition of the photosensitive coating material upon a surface adjacent to the resist to form a film thereupon.

49. The method according to claim 48, wherein the step of providing the photoactive component includes providing a photolytic acid generator for releasing an acid under said exposure, said acid suited to diffuse into the adjacent resist.

50. The method according to claim 48, wherein the step of providing the photoactive component includes providing a photodecomposable alkaline additive, wherein the alkaline additive is arranged to decompose to a non-alkaline, neutral compound within said portions of the photosensitive coating, which are exposed with optical light, UV radiation, X-ray radiation, electrons, charged particles, or ion projection lithography.

51. The method according to claim 48, wherein the step of providing the base polymer includes providing a water-soluble base polymer for enabling an exposure in dry, air-based exposure systems.

52. The method according to claim 48, wherein the step of providing the base polymer includes providing a base polymer that is soluble with respect to a developer comprising Tetramethylammoniumhydroxide (TMAH) dissolved in water and additives.

53. The method according to claim 48, wherein the step of providing the base polymer includes providing a base polymer that is soluble with respect to a solvent, which is based on a mixture of water and isopropanole, for enabling an exposure in an immersion-based exposure system.

54. The method according to claim 48, wherein the step of providing the base polymer comprises providing a base polymer having carboxylic acid groups.

55. The method according to claim 48, wherein the step of providing a base polymer comprises providing a base polymer having alcoholic functions.

56. The method according to claim 48, wherein the step of providing photolytic acid generator comprises providing a photolytic acid generator, which is a Crivello salt, ortho-Nitro-benzylcompounds, AsF₆ or SbF₆, Phthalimidotosylates or related sulphonic nitrogen bound esters of Phthalimides.

57. The method according to claim 48, wherein the step of providing the alkaline additive includes providing organic amines.

58. A method of exposing a semiconductor wafer, the method comprising the method steps of:
A) applying a resist to the semiconductor wafer to form a resist film, the resist film comprising a resist base polymer;
B) applying a first photosensitive coating material to said semiconductor wafer to form a first contrast enhancing layer (CEL) upon the resist, said first contrast enhancing layer comprising a first CEL base polymer, a first alkaline additive and a first photoactive component;
C) exposing said first contrast enhancing layer and the underlying resist film within a first portion with optical light, UV radiation, X-ray radiation, electrons, charged particles, or ion projection lithography, wherein:
a concentration of the first alkaline additives in first exposed portions of the first contrast enhancing layer is reduced or neutralized due the exposure of the first photoactive component, and
a concentration of acids in first exposed portions of the resist film is increased;
D) diffusing the first alkaline additive remaining in unexposed portions of the first contrast enhancing layer into a surface region of the adjacent resist film to increase the contrast in acid concentration between first exposed and unexposed portions therein; and
E) developing the resist film to remove either an exposed or an unexposed portion thereof.

59. The method according to claim 58, wherein the step of diffusing the first alkaline additive into the resist film is performed in a separate method step C1) after step C) by means of a first post exposure bake step.

60. The method according to claim 58, further comprising in method step E) developing both exposed and unexposed portions the first contrast enhancing layer, wherein the further development of the coating film is performed selectively with respect to the underlying resist film.

61. The method according to claim 58, wherein during step A) the first alkaline additive is provided as the first photoactive component, and wherein exposing the coating film includes decomposing the first alkaline additive to a non-alkaline, neutral compound within the exposed portions of the photosensitive coating in order to reduce or neutralize the concentration of first alkaline additives formed therein.

62. The method according to claim 58, wherein the resist film is photosensitive and further comprises a resist photolytic acid generator and wherein during said exposure of said first contrast enhancing layer and underlying resist, the concentration of acids in exposed portions of the resist film is increased due to the exposure of the resist photolytic acid generator and diffusing the first alkaline additive remaining in unexposed portions of the first contrast enhancing layer into a surface region of the adjacent resist film decreases or neutralizes an acid concentration in unexposed portions of the resist film.

63. The method according to claim 58, wherein the resist film is photoinsensitive and the resist base polymer includes acid-sensitive functional groups, and wherein during exposure of said first contrast enhancing layer and underlying resist the concentration of acids in exposed portions of the resist film is increased due to the diffusion of the acids formed from by the first photoactive component of the contrast enhancing layer into the adjacent resist film, reacting with the acid-sensitive functional groups of the resist film.

64. The method according claim 58, wherein during method step A) a first photolytic acid generator is provided as the first photoactive component, and wherein method step C) includes diffusing acids generated by the first photolytic generator within first exposed regions of the first contrast enhancing layer into first exposed portions of the resist film in order to increase the acid concentration therein.

65. The method according to claim 64, wherein the acids generated by the first photolytic generator comprise charged or polar acids and wherein during the diffusion of the acids generated by the first photolytic generator of the first contrast enhancing layer into first exposed portions of the resist film an electrical field is applied to the resist film and the first contrast enhancing layer in order to directionally diffuse the charged or polar acids into the first exposed portions of the resist film.

66. The method according to claim 65, further comprising applying an electrical field of 50V to 8000V.

67. The method according to claim 58, further comprising the method steps of:
C2) after method steps C), removing the first contrast enhancing layer;
C3) applying a second photosensitive coating material to said semiconductor wafer to form a second contrast enhancing layer (CEL) upon the resist, said second contrast enhancing layer comprising a second CEL base polymer, a second alkaline additive and a second photoactive component;
C4) exposing said second contrast enhancing layer and the underlying resist film within a second portion with optical light, UV radiation, X-ray radiation, electrons, charged particles, or ion projection lithography, wherein:
a concentration of the second alkaline additives in second exposed portions of the second contrast enhancing layer is reduced or neutralized due the exposure of the second photoactive component, and
a concentration of acids in second exposed portions of the resist film is increased, and
diffusing the second alkaline additive remaining in unexposed portions of the second contrast enhancing layer into a surface region of the adjacent resist film to increase the contrast in acid concentration between second exposed and unexposed portions therein.

68. The method according to the claim 67, further comprising the method step of:
C5) diffusing the second alkaline additive into the resist film by means of a second post exposure bake step.

69. The method according to claim 68, wherein during method step C3) a second photolytic acid generator is provided as the second photoactive component, and wherein method steps C4) or C5) include diffusing acids generated by the second photolytic generator within second exposed regions of the second contrast enhancing layer into second exposed portions of the resist film in order to increase the acid concentration therein.

70. The method according to claim 69, wherein the acids generated by the second photolytic generator comprise charged or polar acids and wherein during the diffusion of the acids generated by the second photolytic generator of the second contrast enhancing layer into second exposed portions of the resist film an electrical field is applied to the resist film and the second contrast enhancing layer in order to directionally diffuse the charged or polar acids into the second exposed portions of the resist film.

71. The method according to claim 68, wherein the first and second exposed portions are chosen in such a way in the method steps C) and C4) that the first and second portions are dislocated relative to each other in the resist film.

72. The method according to claim 68, wherein in method step E) first and second structures are formed in the resist film by removing either the first and second exposed portions or by removing the unexposed portions of the resist film.

73. The method according to claim 58, further comprising the method step of:
A1) prior to method step A), applying a third photosensitive coating material to said semiconductor wafer to form a bottom contrast enhancing layer (BCEL) on the semiconductor wafer, said bottom contrast enhancing layer comprising a third BCEL base polymer, which is free of any acid-sensitive groups, a third alkaline additive, and a third photoactive component,
wherein in method step A) the resist film is formed on said bottom contrast enhancing layer.

74. The method step according to claim 68, further comprising the method step of:
A1) prior to method step A), applying a third photosensitive coating material to said semiconductor wafer to form a bottom contrast enhancing layer (BCEL) on the semiconductor wafer, said bottom contrast enhancing layer comprising a third BCEL base polymer, which is free of any acid-sensitive groups, a third alkaline additive, and a third photoactive component,
wherein in method step A) the resist film is formed on said bottom contrast enhancing layer, and
wherein during the exposure in the method steps C), C1) and/or C4), C5) the first and/or second alkaline additive and the third alkaline additive are diffusing into unexposed portions of the adjacent resist film.

75. The method according to claim 74, wherein during method step A1) a third photolytic acid generator is provided as the third photoactive component, and wherein method steps C), C1) and/or C4), C5) include diffusing acids generated by the third photolytic generator within first and/or second exposed regions of the bottom contrast enhancing layer into first and/or second exposed portions of the resist film in order to increase the acid concentration therein.

76. The method according to claim 74, wherein the acids generated by the third photolytic generator comprise charged or polar acids and wherein during the diffusion of the acids generated by the third photolytic generator of the bottom contrast enhancing layer into first and/or second exposed portions of the resist film an electrical field is applied between the resist film, the first and/or second contrast enhancing layer and the bottom contrast enhancing layer in order to directionally diffuse the charged or polar acids into the first and/or second exposed portions of the resist film.

77. The method according to claim 76, further comprising applying an alternating electrical field.

78. The method according to claim 73, wherein the third photosensitive coating material also comprises a third alkaline additive.
